(19) United States
(12) Patent Application Publication
(10) Pub. No.: US 2024/0306149 A1
(43) Pub. Date: Sep. 12, 2024

(54) INTELLIGENT CARRIER AGGREGATION FOR TWO-WAY TRAFFIC

(71) Applicant: T-Mobile USA, Inc., Bellevue, WA (US)

(72) Inventor: Muhammad Tawhidur Rahman, Bellevue, WA (US)

(21) Appl. No.: 18/180,842

(22) Filed: Mar. 8, 2023

(51) Int. Cl. H04W 72/1273; H04L 5/00; H04L 5/14; H04W 36/00; H04W 72/543

(52) U.S. Cl. CPC H04W 72/1273; H04L 5/0098; H04L 5/14; H04W 36/0069; H04W 72/543

(57) ABSTRACT

Intelligent carrier aggregation (CA), specifically downlink (DL) CA, prevents two-way traffic from being steered to a DL-only secondary cell (s-cell). Solutions include: determining, by a node (e.g., a gNodeB) of a wireless network, that two concurrent data traffic sessions terminate at a single user equipment (UE); determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, performing CA in which the first data traffic session is retained by a primary cell (p-cell) and the second data traffic session is steered to a s-cell.

### BACKGROUND

Carrier aggregation (CA) is a technique that increases the data rate for a particular user, by assigning multiple frequency bands to a single user equipment (UE). CA is available in some fourth generation (4G) and fifth generation (5G) cellular networks, although implemented primarily to increase downlink (DL) data rates. With CA, a UE will be served by a primary cell (p-cell) that operates normally, carrying two-way data traffic. The additional bandwidth is provided by one or more secondary cells (s-cells), and the serving base station will steer some of the UE's data traffic to a s-cell.

For DL-only CA, a s-cell will handle one-way data traffic, only the downlink. If two-way data traffic, such as a live voice call, is steered to a DL-only s-cell, voice data from the UE, intended to go to the distant end party, will not be transmitted. This will prevent the distant end party from hearing voice signals from the UE.

### SUMMARY

The following summary is provided to illustrate examples disclosed herein but is not meant to limit all examples to any particular configuration or sequence of operations.

Intelligent carrier aggregation (CA), specifically downlink (DL) CA, prevents two-way traffic from being steered to a one-way traffic cell, such as a downlink (DL) only secondary cell (s-cell). Solutions include: determining, by a node (e.g., a gNodeB) of a wireless network, that two concurrent data traffic sessions terminate at a single user equipment (UE): determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, performing CA in which the first data traffic session is retained by a primary cell (p-cell) and the second data traffic session is steered to a secondary cell (s-cell).

### BRIEF DESCRIPTION OF THE DRAWINGS

The disclosed examples are described below with reference to the accompanying drawing figures listed below, wherein:

FIG. 1 illustrates an exemplary architecture that advantageously provides intelligent CA;

FIG. 2 illustrates a possible CA scenario for the architecture of FIG. 1;

FIG. 3 illustrates a data traffic flow arrangement that may be used in the architecture of FIG. 1;

FIG. 4 illustrates a flowchart of exemplary operations associated with the architecture of FIG. 1;

FIG. 5 illustrates another flowchart of exemplary operations associated with the architecture of FIG. 1; and

FIG. 6 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Intelligent carrier aggregation (CA), specifically downlink (DL) CA, prevents two-way traffic from being steered to a one-way traffic cell, such as a downlink (DL) only secondary cell (s-cell). Solutions include: determining, by a node (e.g., a gNodeB) of a wireless network, that two concurrent data traffic sessions terminate at a single user equipment (UE); determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, performing CA in which the first data traffic session is retained by a primary cell (p-cell) and the second data traffic session is steered to a s-cell.

Aspects of the disclosure improve the reliability and performance of cellular communications by preventing two-way traffic from being steered to a one-way traffic cell, such as a DL-only s-cell. This is accomplished, at least in part, by based on at least determining that the concurrent two-way plus one-way data traffic session condition exists, performing CA in which the first data traffic session is retained by a p-cell and the second data traffic session is steered to a s-cell. In some examples, CA may use multiple s-cells.

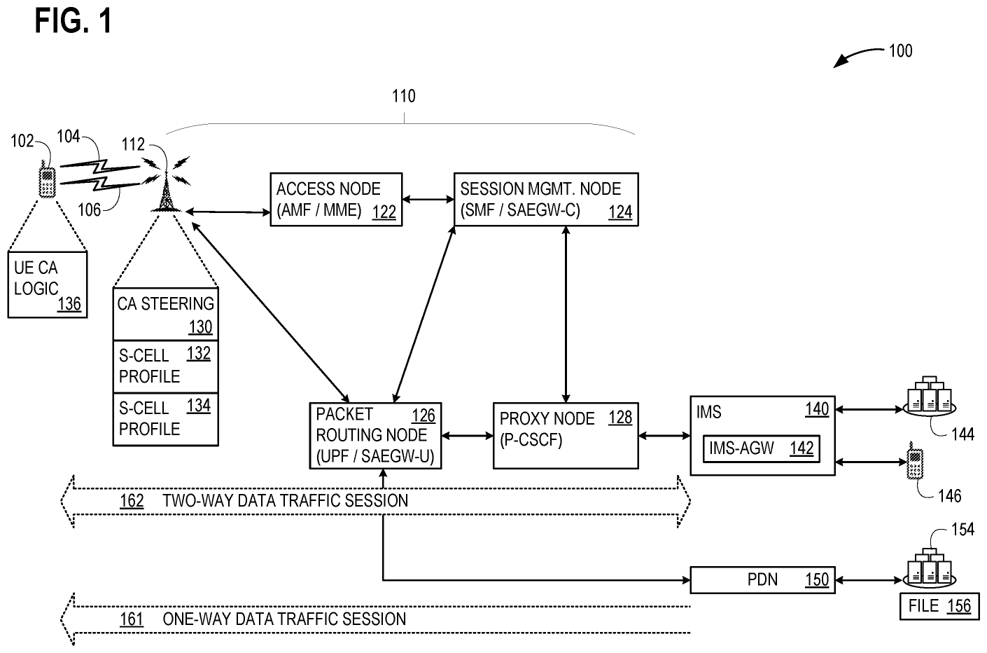

With reference now to the figures, FIG. 1 illustrates an architecture 100 that advantageously provides intelligent CA. Specifically, architecture 100 prevents two-way traffic from being steered to a one-way traffic s-cell, such as a DL-only s-cell in a wireless network 110. Wireless network 110 has a node 112, which is a radio access network (RAN) node, which comprises a base station. Wireless network 110 also has an access node 122, a session management node 124, a packet routing node 126, and a proxy node 128. In some examples, proxy node 128 comprises a proxy call session control function (P-CSCF).

In fifth generation (5G) cellular examples, node 112 comprises a gNode B (gNB), access node 122 comprises an access mobility function (AMF), session management node 124 comprises a session management function (SMF), and packet routing node 126 comprises a user plane function (UPF). In fourth generation (4G) cellular examples, node 112 comprises an eNodeB (eNB), access node 122 comprises a mobility management entity (MME), session management node 124 comprises a system architecture evolution gateway (SAEGW) control plane (SAEGW-C), and packet routing node 126 comprises a SAEGW-user plane (SAEGW-U). An SAEGW is a combination of a serving gateway (SGW) and a packet data network gateway (PGW).

Proxy node 128 communicates with an internet protocol (IP) multimedia system (IMS) 140, which has an IMS access gateway (IMS-AGW) 142. IMS 140 connects wireless network 110 with a remote media resource 144 and other telephones and UEs, such as a UE 146. Packet routing node 126 connects to a packet data network (PDN) 150 (e.g., the internet), which provides access to a remote network resource 154, such as a location from which large data files, such as file 156, may be downloaded by UE 102.

A UE 102 has supporting UE CA logic 136 that permits UE 102 to support CA, for example by mapping different packets to different quality of service (QOS) flows in 5G cellular service or different data bearers in 4G cellular service. In some examples, UE 102 implements CA by following the instructions provided by a node 112 of wireless network 110.

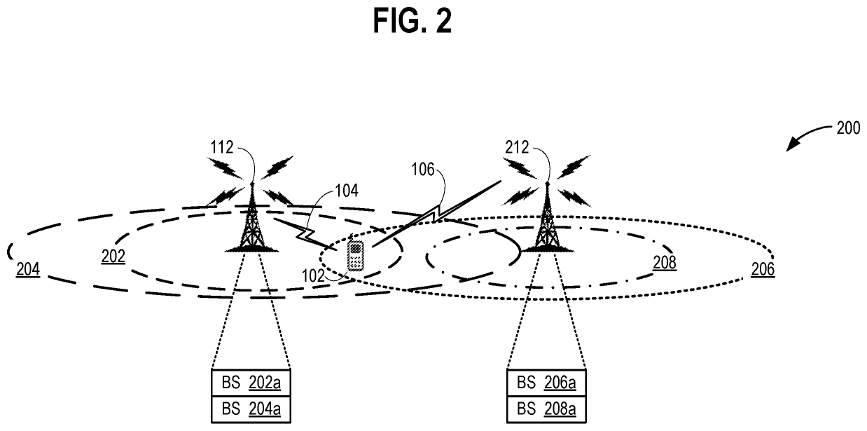

UE 102 communicates with node 112 using an air interface 104 for one assigned frequency band, such as the p-cell, and an air interface 106 for another assigned frequency band, such as a s-cell-when the p-call and s-cell are co-located. A scenario in which the p-call and s-cell are not co-located is shown in FIG. 2, and described later. Although only a single s-cell per cell site is illustrated, it should be understood that multiple s-cells may exist per cell site, and that a UE may simultaneously use both an s-cell that is co-located with the p-cell and also use another s-cell that is not co-located with the p-cell.

Node 112 has CA steering logic 130, which enables node 112 to steer various data traffic sessions (e.g., QoS flows and data bearers) to different cells. CA steering logic 130 uses a s-cell creation profile 132 and a s-cell creation profile 134. S-cell creation profile 132 is used when UE 102 has multiple data traffic sessions, with at least one data traffic session having two-way traffic and at least one data traffic session having one-way DL traffic. This situation can arise, for example when UE 102 has a live voice call (two-way traffic) while also downloading a large file (one-way data-only traffic). S-cell creation profile 132 prevents node 112 from steering the two-way data traffic session to a DL-only s-cell, but permits node 112 to steer the one-way DL data traffic session to a DL-only s-cell.

S-cell creation profile 134 is used when UE 102 has multiple one-way DL data traffic sessions, and no two-way data traffic sessions. This situation can arise, for example when UE 102 is downloading two large files simultaneously. S-cell creation profile 134 permits node 112 to steer either of the one-way DL data traffic sessions to a DL-only s-cell.

As illustrated, UE 102 has two concurrent data traffic sessions: a two-way data traffic session 162, and a one-way (DL-only) data traffic session 161. Data traffic session 162 carries, for example, voice packet data for a live voice call between UE 102 and UE 146, while data traffic session 161 carries, for example, downloaded date for a large file 156 from remote network resource 154. In this illustrated scenario, node 112 recognizes the concurrent two-way plus one-way data traffic session condition for UE 102, and selects s-cell creation profile 132 that will retain data traffic session 162 on the two-way p-cell while permitting data traffic session 161 to be steered to a s-cell.

FIG. 2 illustrates a possible CA scenario 200 for architecture 100, in which UE 102 is using CA with a s-cell that is not co-located with the p-cell for UE 102. In scenario 200, the p-cell for UE 102 is cell 204, provided by a base station 204a, and using air interface 104. The s-cell for UE 102 is cell 206, provided by a base station 206a, and using air interface 106. In an alternative scenario (with a co-located p-cell and s-cell) the s-cell may be cell 202, provided by a base station 202a, or even a different frequency band provided by base station 204a.

When UE 102 moves away from node 112, toward a node 212 (which is already hosting the s-cell for UE 102), a version of CA steering logic 130 within node 212 will recognize the concurrent two-way plus one-way data traffic session condition for UE 102, select its own copy of s-cell creation profile 132 that will retain data traffic session 162 on the new two-way p-cell while permitting data traffic session 161 to remain on the s-cell. In this example, upon handoff, the new p-cell will be cell 208, provided by a base station 208a.

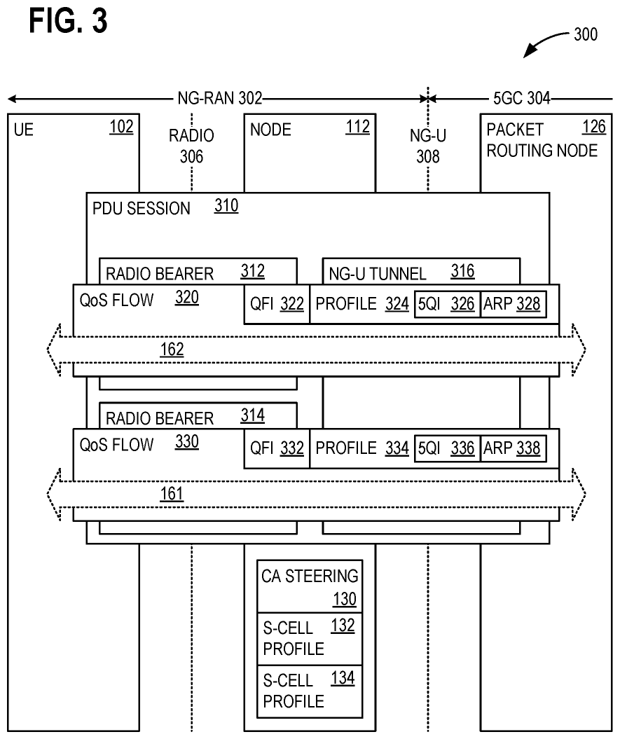

FIG. 3 illustrates a data traffic flow arrangement 300 that may be used in 5G examples of architecture 100, to demonstrate how aspects of the disclosure operate with Qos flows. 4G operation is similar, although using data bearers.

A next generation (NG) radio access network (NG-RAN) 302 is represented by UE 102 and node 112 which, in 5G, comprises a gNB, and packet routing node 126 which, in 5G, comprises a UPF and sits in the edge of a 5G core network (5GC) 304. UE 102 and node 112 are communicatively coupled with a radio interface 306, while node 112 and packet routing node 126 are communicatively coupled with an NG user plane interface (NG-U) 308. A protocol data unit (PDU) session 310 is used to transfer data to/from UE 102 when the p-cell and s-cell are co-located with the same base station. When the p-cell and s-cell use different base stations, two PDU sessions are needed-one for each of the p-cell and s-cell.

As illustrated, node 112 uses two radio bearers to transfer data over air interfaces 104 and 106 to UE 102. A radio bearer 312 is used for air interface 104, and a radio bearer 314 is used for air interface 106. An NG-U tunnel 316 transfers data between node 112 and packet routing node 126. A QoS flow 320 carries (two-way) data traffic session 162, and a QoS flow 330 carries (one-way) data traffic session 161.

5GC 304, which includes session management node 124, provides QoS flow specifications, such as QoS flow identifiers (QFIs) and QoS profiles. A QFI identifies a QoS flow, and is used for mapping packets to a QoS flow, while a QoS profile holds QoS flags, such as a QoS class identifier (QCI), called a 5QI for 5G, and an allocation and retention priority (ARP) level. 5QI values (and QCI values in 4G) identify whether a QoS flow is a guaranteed bit rate (GBR) or non-GBR connection, the type of resource, the default packet priority level, a packet delay budget, and other specifications. An ARP level indicates a priority level for the allocation and retention of bearers and is used to decide whether to accept a request to establish a bearer, or reject the request when resources are limited.

As shown, QoS flow 320 has a QFI 322, and a QoS profile 324 that has a 5QI value 326 and an ARP level 328. QoS flow 330 has a QFI 332, and a QoS profile 334 that has a 5QI value 336 and an ARP level 338. QoS flows 320 and 330 are each mapped to a data network name (DNN). Any of a5QI (or QCI) value, ARP level, and DNN may be used by CA steering logic 130, alone or in combination with any other(s), to determine (e.g., by inference, in some examples), whether a particular QoS flow will have two-way traffic or is likely to have only one-way traffic.

For example, a 5QI value of 1 is for conversational voice, which will be two-way communication, and a 5QI value of 2 is for conversational video (e.g., a video call), which will also be two-way communication. Other 5QI values for likely two-way communication include 3 for real-time gaming and vehicle-to-everything (V2X), which includes vehicle-to-vehicle (V2V), and 75 (also V2X). For 4G, a QCI value of 79 is for V2X and 7 is for interactive gaming, and values 1, 2, and 3 are similar. A 5QI or QCI value of 4, however is for non-conversational video (Buffered Streaming), which may be one-way only.

An ARP level, during setup also provides an indication of the QoS flow characteristics. A DNN name indicating a distant end within IMS 140 indicates a higher likelihood of two-way data traffic, whereas a DNN name indicating a distant end within PDN 150 may indicates a higher likelihood of one-way data traffic. Thus, between a 5QI or QCI value, an ARP level, and a DNN, CA steering logic 130 is able to determine whether data traffic is two-way or one-way. When there are two or more data traffic sessions (QOS flows for 5G or data bearers for 4G), and CA steering logic 130 makes a determination of two-way or one-way for each, CA steering logic 130 is then further able to determine whether a concurrent two-way plus one-way data traffic session condition exists.

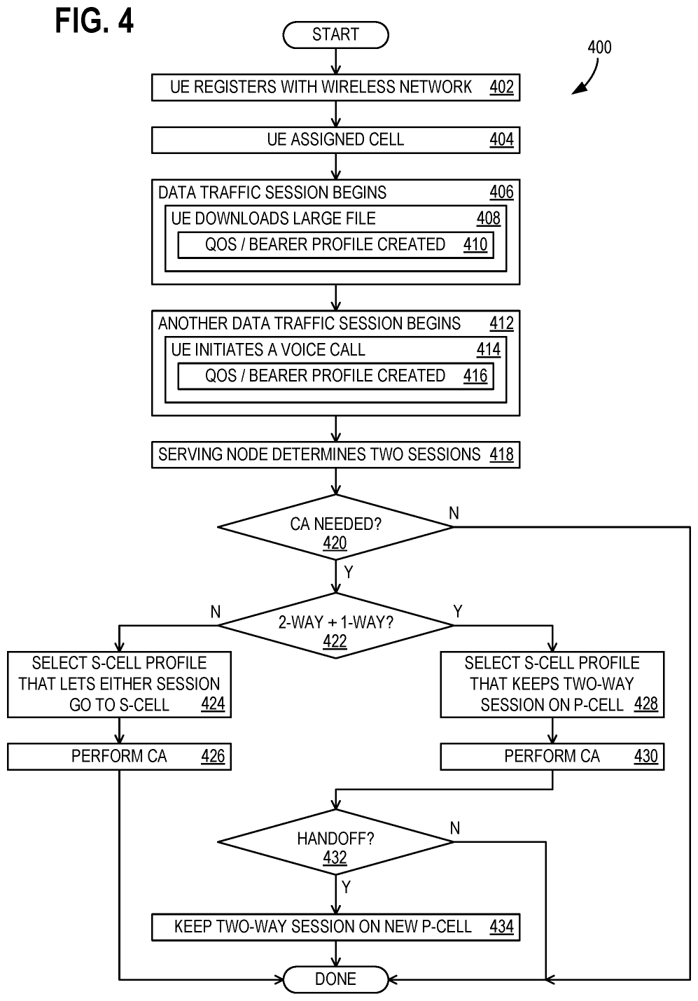

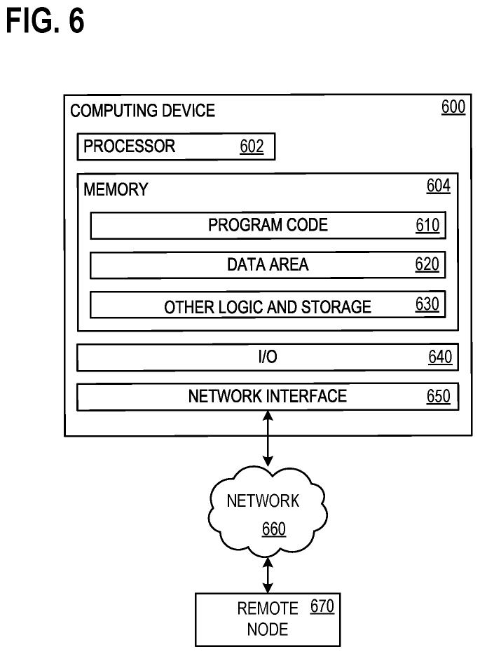

FIG. 4 illustrates a flowchart 400 of exemplary operations associated with providing intelligent CA for UE 102 over wireless network 110. In some examples, at least a portion of flowchart 400 may be performed using one or more computing devices 600 of FIG. 6. Flowchart 400 commences with UE 102 registering with wireless network 110 in operation 402. In operation 404, UE 102 is assigned a cell at node 112, which will become the p-cell. In some examples, node 112 comprises a first base station, which comprises a gNB or an eNB.

Data traffic session 161 commences in operation 406, which includes UE 102 beginning to download a large file from remote network resource 154 over PDN 150, in operation 408, and node 112 receiving QoS profile 334 for QoS flow 330 to support the file download, in operation 410. In some examples, data traffic session 161 has a 5QI or QCI value of 4.

Data traffic session 162 commences in operation 412, which includes UE 102 initiating (or receiving) a voice or video call with (or from) UE 146 via IMS 140, in operation 414, and node 112 receiving QoS profile 324 for QoS flow 320 to support the call, in operation 416. In some examples, data traffic session 162 comprises a voice call, a video call, real-time gaming communication, interactive gaming communication, a rich communication service (RCS), or V2X communication. In some examples, data traffic session 162 has a 5QI or QCI value of 1, 2, 3 or 79 (5G) or 75 (4G).

Node 112 determines that two concurrent data traffic sessions terminate at a single UE (UE 102) in operation 418, and determines whether CA is needed in decision operation 420. CA may be needed, for example, if the bandwidth of data traffic sessions 161 and 162 is overburdening a single radio bearer. If CA is not needed, flowchart 400 terminates.

If CA is needed, then in decision operation 422, node 112 determines whether a concurrent two-way plus one-way data traffic session condition exists. In some examples, CA steering logic 130 of node 112 uses a QoS indicator (e.g., QoS flags from QoS profiles 324 and 334) to determine a traffic type. This provides an indication of whether the traffic will be one-way or two-way. In some examples, the QoS indicator is a QCI value, a 5QI value, or an ARP level, and in some examples both a QCI/5QI value and ARP level are both used. In some examples, the DNNs associated with the QoS flows are used to determine whether traffic is likely to be one-way or two-way. In the example illustrated in FIG. 1, a concurrent two-way plus one-way data traffic session condition does exist, in which data traffic session 162 comprises a two-way data traffic session and data traffic session 161 does not comprise a two-way data traffic session.

If no concurrent two-way plus one-way data traffic session condition exists (e.g., a concurrent two-way plus one-way data traffic session condition does not exist), CA steering logic 130 selects s-cell creation profile 134 that permits either of the two concurrent data traffic sessions to be steered to a s-cell in operation 424. CA is performed in operation 426 that permits either of the two concurrent data traffic sessions to be steered to a s-cell.

Otherwise, if a concurrent two-way plus one-way data traffic session condition does exist, operation 428 selects s-cell creation profile 132 that prevents steering data traffic session 162 to a s-cell. Based on at least decision operation 422 determining that a concurrent two-way plus one-way data traffic session condition exists, operation 430 performs CA in which data traffic session 162 is retained by the p-cell and data traffic session 161 is steered to a s-cell (or at least is permitted to be steered to a s-cell). In some examples, the s-cell uses a base station (such as a gNB) that is not co-located with the p-cell base station, although in some examples, the p-cell and the s-cell are co-located.

Decision operation 432 determines whether a handoff of the p-cell is needed. If so, during a hand-off of UE 102 to a new p-cell, operation 434 prevents steering of data traffic session 162 to a s-cell.

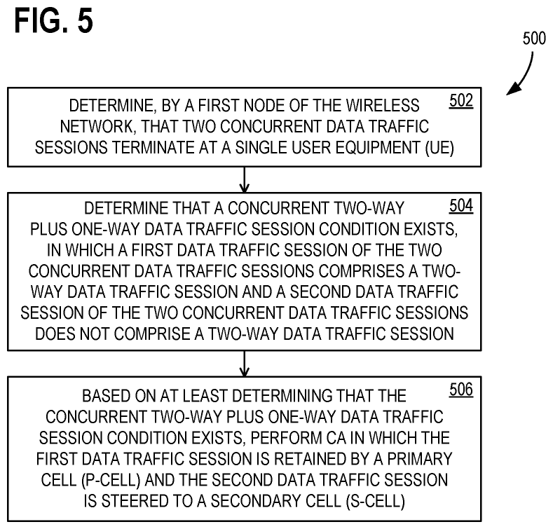

FIG. 5 illustrates a flowchart 500 of exemplary operations associated with examples of architecture 100. In some examples, at least a portion of flowchart 500 may be performed using one or more computing devices 600 of FIG. 6. Flowchart 500 commences with operation 502, which includes determining, by a node of a wireless network, that two concurrent data traffic sessions terminate at a single UE. Operation 504 includes determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session. Operation 506 includes, based on at least determining that the concurrent two-way plus one-way data traffic session condition exists, performing CA in which the first data traffic session is retained by a p-cell and the second data traffic session is steered to a s-cell.

FIG. 6 illustrates a block diagram of computing device 600 that may be used as any component described herein that may require computational or storage capacity. Computing device 600 has at least a processor 602 and a memory 604 that holds program code 610, data area 620, and other logic and storage 630. Memory 604 is any device allowing information, such as computer executable instructions and/or other data, to be stored and retrieved. For example, memory 604 may include one or more random access memory (RAM) modules, flash memory modules, hard disks, solid-state disks, persistent memory devices, and/or optical disks. Program code 610 comprises computer executable instructions and computer executable components including instructions used to perform operations described herein. Data area 620 holds data used to perform operations described herein. Memory 604 also includes other logic and storage 630 that performs or facilitates other functions disclosed herein or otherwise required of computing device 600. An input/output (I/O) component 640 facilitates receiving input from users and other devices and generating displays for users and outputs for other devices. A network interface 650 permits communication over a network 660 with a remote node 670, which may represent another implementation of computing device 600. For example, a remote node 670 may represent another of the above-noted nodes within architecture 100.

### ADDITIONAL EXAMPLES

An example method of providing CA over a wireless network comprises: determining, by a node of the wireless network, that two concurrent data traffic sessions terminate at a single UE: determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, performing CA in which the first data traffic session is retained by a p-cell and the second data traffic session is steered to a s-cell.

An example system for providing CA over a wireless network comprises: a processor; and a computer-readable medium storing instructions that are operative upon execution by the processor to: determine, by a node of the wireless network, that two concurrent data traffic sessions terminate at a single UE: determine that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, perform CA in which the first data traffic session is retained by a p-cell and the second data traffic session is steered to a s-cell.

One or more example computer storage devices has computer-executable instructions stored thereon, which, upon execution by a computer, cause the computer to perform operations comprising: determining, by a node of a wireless network, that two concurrent data traffic sessions terminate at a single UE: determining that a concurrent two-way plus one-way data traffic session condition exists, in which a first data traffic session of the two concurrent data traffic sessions comprises a two-way data traffic session and a second data traffic session of the two concurrent data traffic sessions does not comprise a two-way data traffic session; and based on at least determining that the concurrent two-way plus one-way data traffic session condition exists, performing CA in which the first data traffic session is retained by a p-cell and the second data traffic session is steered to a s-cell.

Alternatively, or in addition to the other examples described herein, examples include any combination of the following:
based on at least determining that the concurrent two-way plus one-way data traffic session condition exists, selecting a first s-cell creation profile that prevents steering the first data traffic session to a s-cell;
based on at least determining that a concurrent two-way plus one-way data traffic session condition does not exist, selecting a second s-cell creation profile that permits either of the two concurrent data traffic sessions to be steered to a s-cell;
determining whether a concurrent two-way plus one-way data traffic session condition exists comprises using a QoS indicator to determine a traffic type;
the QoS indicator comprises an indicator selected from the list consisting of: a QCI value, a 5QI value, and an ARP level;
the first data traffic session comprises a voice call or a video call;
during a hand-off of the UE, preventing steering of the first data traffic session to a s-cell;
the p-cell uses a first base station and the s-cell uses a second base station that is not co-located with the first base station;
the first node comprises a first base station;
the first node comprises a gNB;
the second base station comprises a gNB;
the p-cell and the s-cell are co-located;
determining whether a concurrent two-way plus one-way data traffic session condition exists comprises both an ARP level and either a 5QI value or a QCI value;
determining whether a concurrent two-way plus one-way data traffic session condition exists further comprises using a DNN;
the first data traffic session comprises at least one data traffic session selected from the list consisting of: a voice call, a video call, real-time gaming communication, interactive gaming communication, an RCS, and V2X communication;
the first data traffic session has a 5QI value of 1, 2, 3, or 79 and the second data traffic session has a 5QI value of 4; and
the first data traffic session has a QCI value of 1, 2, 3, or 75 and the second data traffic session has a QCI value of 4.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of providing carrier aggregation (CA) over a wireless network, the method comprising:
determining, by a node of the wireless network, that two concurrent data traffic sessions terminate at a single user equipment (UE);
determining that a concurrent two-way plus one-way data traffic session condition exists, in which a first data traffic session of the two concurrent data traffic sessions comprises a two-way data traffic session and a second data traffic session of the two concurrent data traffic sessions does not comprise the two-way data traffic session; and
based on at least determining that the concurrent two-way plus one-way data traffic session condition exists, performing CA in which the first data traffic session is retained by a primary cell (p-cell) and the second data traffic session is steered to a secondary cell (s-cell).

2. The method of claim 1, further comprising:
based on at least determining that the concurrent two-way plus one-way data traffic session condition exists, selecting a first s-cell creation profile that prevents steering the first data traffic session to the s-cell; and
based on at least determining that no concurrent two-way plus one-way data traffic session condition exists, selecting a second s-cell creation profile that permits either of the two concurrent data traffic sessions to be steered to the s-cell.

3. The method of claim 1, wherein determining whether the concurrent two-way plus one-way data traffic session condition exists further comprises:
using a quality of service (QOS) indicator to determine a traffic type.

4. The method of claim 3, wherein the QoS indicator comprises an indicator selected from the list consisting of:
a QoS class identifier (QCI) value, a fifth generation (5G) QCI (5QI) value, and an allocation and retention priority (ARP) level.

5. The method of claim 1, wherein the first data traffic session comprises a voice call or a video call.

6. The method of claim 1, further comprising:
during a hand-off of the UE, preventing steering of the first data traffic session to the s-cell.

7. The method of claim 1, wherein the p-cell uses a first base station and the s-cell uses a second base station that is not co-located with the first base station.

8. A system for providing carrier aggregation (CA) over a wireless network, the system comprising:
a processor; and
a computer-readable medium storing instructions that are operative upon execution by the processor to:
determine, by a node of the wireless network, that two concurrent data traffic sessions terminate at a single user equipment (UE);
determine that a concurrent two-way plus one-way data traffic session condition exists, in which a first data traffic session of the two concurrent data traffic sessions comprises a two-way data traffic session and a second data traffic session of the two concurrent data traffic sessions does not comprise the two-way data traffic session; and
based on at least determining that the concurrent two-way plus one-way data traffic session condition exists, perform CA in which the first data traffic session is retained by a primary cell (p-cell) and the second data traffic session is steered to a secondary cell (s-cell).

9. The system of claim 8, wherein the instructions are further operative to:
based on at least determining that the concurrent two-way plus one-way data traffic session condition exists, select a first s-cell creation profile that prevents steering the first data traffic session to the s-cell; and
based on at least determining that no concurrent two-way plus one-way data traffic session condition exists, select a second s-cell creation profile that permits either of the two concurrent data traffic sessions to be steered to the s-cell.

10. The system of claim 8, wherein determining whether the concurrent two-way plus one-way data traffic session condition exists further comprises:
using a quality of service (QOS) indicator to determine a traffic type.

11. The system of claim 10, wherein the QoS indicator comprises an indicator selected from the list consisting of:
a QoS class identifier (QCI) value, a fifth generation (5G) QCI (5QI) value, and an allocation and retention priority (ARP) level.

12. The system of claim 8, wherein the first data traffic session comprises a voice call or a video call.

13. The system of claim 8, wherein the instructions are further operative to:
during a hand-off of the UE, prevent steering of the first data traffic session to the s-cell.

14. The system of claim 8, wherein the p-cell uses a first base station and the s-cell uses a second base station that is not co-located with the first base station.

15. One or more computer storage devices having computer-executable instructions stored thereon, which, upon execution by a computer, cause the computer to perform operations comprising:
determining, by a node of a wireless network, that two concurrent data traffic sessions terminate at a single user equipment (UE);
determining that a concurrent two-way plus one-way data traffic session condition exists, in which a first data traffic session of the two concurrent data traffic sessions comprises a two-way data traffic session and a second data traffic session of the two concurrent data traffic sessions does not comprise the two-way data traffic session; and
based on at least determining that the concurrent two-way plus one-way data traffic session condition exists, performing carrier aggregation (CA) in which the first data traffic session is retained by a primary cell (p-cell) and the second data traffic session is steered to a secondary cell (s-cell).

16. The one or more computer storage devices of claim 15, wherein the operations further comprise:
based on at least determining that the concurrent two-way plus one-way data traffic session condition exists, selecting a first s-cell creation profile that prevents steering the first data traffic session to the s-cell; and
based on at least determining that no concurrent two-way plus one-way data traffic session condition exists, selecting a second s-cell creation profile that permits either of the two concurrent data traffic sessions to be steered to the s-cell.

17. The one or more computer storage devices of claim 15, wherein determining whether the concurrent two-way plus one-way data traffic session condition exists comprises using a quality of service (QOS) indicator.

18. The one or more computer storage devices of claim 17, wherein the QoS indicator comprises an indicator selected from the list consisting of:
a QoS class identifier (QCI) value, a fifth generation (5G) QCI (5QI) value, and an allocation and retention priority (ARP) level.

19. The one or more computer storage devices of claim 15, wherein the first data traffic session comprises a voice call or a video call.

20. The one or more computer storage devices of claim 15, wherein the operations further comprise:
during a hand-off of the UE, preventing steering of the first data traffic session to the s-cell.
